(19) United States
(12) Patent Application Publication
(10) Pub. No.: US 2026/0126101 A1
(43) Pub. Date: May 7, 2026

(54) ELECTROMECHANICAL ACTUATOR

(71) Applicant: VALEO ELECTRIFICATION, Cergy Pontoise (FR)

(72) Inventors: Sylvain GAUTIER, Cergy Pontoise (FR); Sachidhanandam BASKARAN, Chennai (IN); Sylvain FAVELIER, Cergy Pontoise (FR)

(73) Assignee: VALEO ELECTRIFICATION, Cergy Pontoise (FR)

(21) Appl. No.: 19/118,796

(22) PCT Filed: Nov. 16, 2023
(86) PCT No.: PCT/EP2023/082046

§ 371 Date: Apr. 7, 2025

(30) Foreign Application Priority Data
Dec. 7, 2022 (FR) FR2212913

(51) Int. Cl. F16H 25/20; F16H 25/24

(52) U.S. Cl. CPC F16H 25/2015; F16H 25/24; F16H 2025/2031; F16H 2025/2059; F16H 2025/2081

(57) ABSTRACT

An electromechanical actuator including an electric motor housed in a housing, the electric motor acting on a torque output element capable of being coupled to an element of a transmission gearbox of a motor vehicle. The torque output element is connected to the electric motor by drive means, and the torque output element is a main shaft configured to rotate about its axis of rotation with a first end and a second end. The actuator further includes a circuit board located in the housing, the circuit board comprises a sensor which faces a magnet mounted on a support coupled to the second end of the main shaft by means of a first swivel-linear mechanism.

The invention relates to an electromechanical actuator.

The invention applies more specifically to the field of actuators for a parking lock system for immobilizing a gearbox of a vehicle, notably a motor vehicle equipped with an automatic gearbox, for example a hybrid vehicle. The invention also applies to a parking lock system for immobilizing a reducer associated with an electric vehicle motor. The gearbox or the reducer will more generally be referred to as the transmission gearbox. This locking system is better known as a park-lock or parking lock. Such an actuator allows the transmission gearbox to be immobilized when parked, by means of a lever engaging with a toothset of the transmission gearbox.

The invention also applies to the field of actuators for a system for connecting/disconnecting elements in the transmission of the above-mentioned vehicles.

Actuators of this type are known, for example, from document ES1217209UA. This type of actuator has the disadvantage of proposing a complex mechanism for detecting the position of the main shaft using a worm and wheel system.

It is therefore necessary to propose a system that is less expensive and simpler to implement, while yet remaining effective.

The invention therefore proposes an electromechanical actuator comprising an electric motor housed in a housing, the electric motor acting on a torque output element able to be coupled to an element of a transmission of a motor vehicle, the torque output element being connected to the electric motor by drive means, the torque output element being a main shaft configured to rotate about its axis of rotation with a first end and a second end. The actuator further comprises an electronic board situated inside the housing, the electronic board comprising a sensor that faces a magnet mounted on a support coupled to the second end of the main shaft by means of a first rotary-linear mechanism.

This design allows reliable measurement of the position of the main shaft using a design that is simple and inexpensive.

According to one aspect of the invention, the sensor is preferably a Hall-effect sensor and the magnet is a permanent magnet and is polarized.

Advantageously, the first rotary-linear mechanism is a screw-nut system. The screw part is on the main shaft, more specifically at the second end thereof. The nut part may be the magnet support directly or may be indirectly connected to the magnet support. Any other type of rotary-linear mechanism may be employed as an alternative, for example a ball-screw system.

According to the invention, the main shaft is connected to the electric motor by means of a pinion-wheel system so as to rotate the main shaft. The pinion is on the shaft of the electric motor and the wheel is on the torque output element, namely the main shaft. As a preference, the pinion-wheel system has straight-cut teeth.

According to the invention, the first rotary-linear mechanism is coupled to a surface of the housing in order to perform an anti-rotation function. More specifically, the nut part of the first rotary-linear mechanism is coupled to the surface of the housing.

According to an alternative embodiment, the first rotary-linear mechanism is associated with the magnet support by a cam-slot system. That enables the linear movement of the first rotary-linear mechanism to be converted into a rotation of the magnet support.

According to an additional feature of the invention, a second rotary-linear mechanism is coupled to the first end of the main shaft. The second rotary-linear mechanism enables the rotary movement of the main shaft to be converted into a linear movement. The second rotary-linear mechanism is a screw-nut system, the screw part being on the main shaft, more specifically at the first end thereof, and the nut part being a thrust member. Any other type of rotary-linear mechanism may be employed as an alternative, for example a ball-screw system.

According to another feature of the invention, the travel of the first rotary-linear mechanism is different than the travel of the second rotary-linear mechanism. For example, the ratio between the travel of the first rotary-linear mechanism and the travel of the second rotary-linear mechanism is comprised between 0.1 and 3.

In particular, the travel of the first rotary-linear mechanism may be shorter than the travel of the second rotary-linear mechanism. This feature makes it possible to reduce the travel of the first rotary-linear mechanism associated with the magnet support and to use a standard sensor.

Alternatively, the travel of the first rotary-linear mechanism may be longer than the travel of the second rotary-linear mechanism. This feature makes it possible to increase the measurement precision.

Advantageously, the main shaft is guided in rotation by a rolling bearing, the inner ring of the rolling bearing being in contact with the main shaft and the outer ring of the rolling bearing being in contact with the housing and a flange fixed to the housing. The rolling bearing is preferably a double-row ball bearing because the main shaft is subjected to heavy axial loadings of the order of 700N.

According to one particular feature of the invention, the electric motor comprises a front face facing toward the drive means and a rear face, the housing comprising a removable blanking plug at the rear face of the electric motor. The blanking plug, once removed, advantageously allows access to the motor in order to perform manual operations of engaging or disengaging the locking system.

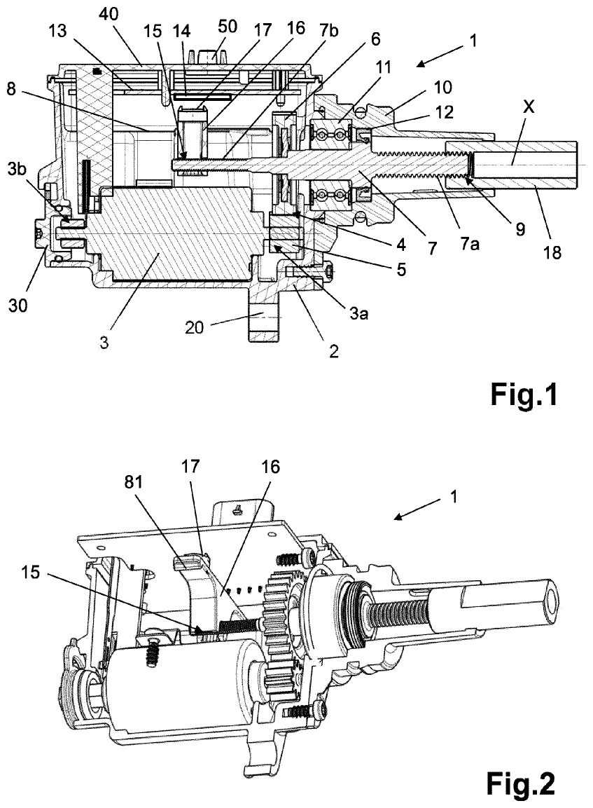

Other features and advantages of the invention will become apparent upon reading the following detailed description of exemplary embodiments, with reference to the appended figures:
FIG. 1 is a sectional view of an actuator according to a first embodiment;
FIG. 2 is a perspective and partially sectional view of the actuator of FIG. 1;

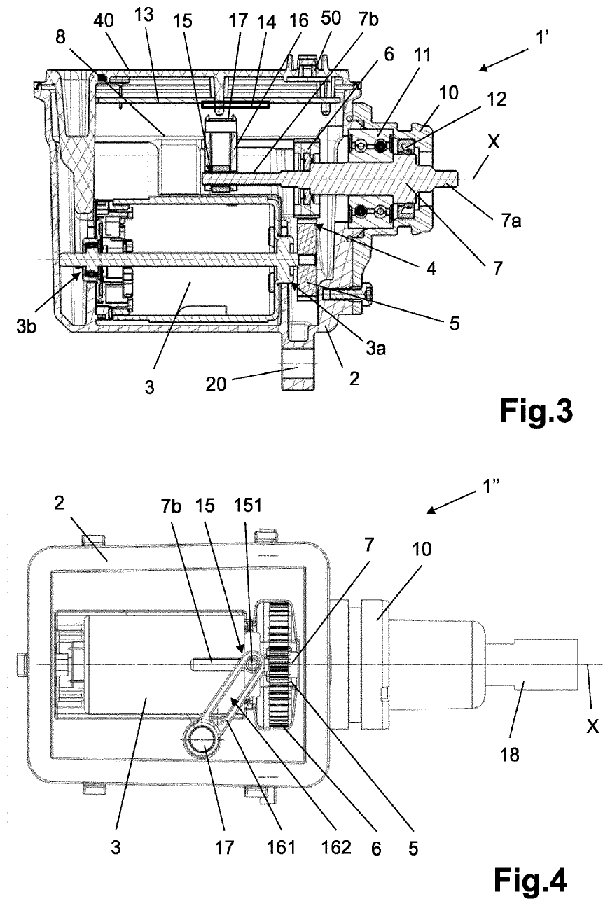

FIG. 3 is a sectional view of an actuator according to a second embodiment;

FIG. 4 is a view from above of an actuator without the cover, according to a third embodiment;

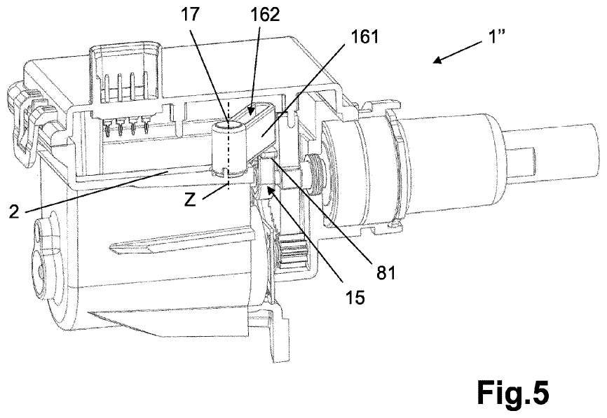

FIG. 5 is a perspective and partially sectional view of the actuator of FIG. 4.

It should be noted that the figures disclose the invention in a sufficiently detailed manner for the implementation thereof, said figures helping to better define the invention as required. However, the invention should not be limited to the embodiments disclosed in the description.

In the first embodiment illustrated in FIG. 1, the electromechanical actuator 1 comprises a DC electric motor 3 housed inside a housing 2 made, for example, from aluminum or from plastic. The electric motor 3 comprises a front face 3a and a rear face 3b. The housing 2 comprises a removable blanking plug 30 at the rear face 3b of the electric motor 3. The housing 2 may be fixed to the transmission gearbox by fixing eyes 20. In its upper part, the housing 2 is closed by means of a cover 40, this cover 40 comprising a membrane 50 that is permeable to gases and impermeable to liquids. The cover 40 incorporates an electrical connector so that the actuator 1 can be electrically powered.

The electric motor 3 acts on a thrust member 18 configured to perform a predetermined linear movement (an extending and retracting movement) so as to come into contact with an external mechanism (not depicted) in the transmission gearbox.

The thrust member 18 is connected to the electric motor 3 by means of a main shaft 7 axially aligned with the thrust member 18. The main shaft 7 is preferably made of metal and is configured to rotate about its axis of rotation X. A first end 7a of the main shaft 7, namely the end facing the element of the transmission gearbox, is coupled to the thrust member 18 by a rotary-linear mechanism 9 so that the thrust member 18 can move translationally and, simultaneously, rotationally with respect to the main shaft 7 when the main shaft 7 is rotating. The rotary-linear mechanism 9 is a screw-nut system. The first end 7a of the main shaft 7 has an externally threaded section that is coupled to a threaded section present in an internal cavity of the thrust member 18.

The main shaft 7 is connected to the electric motor 3 by drive means 4, namely a pinion-wheel system so as to rotate the main shaft 7. The toothed wheel 6 of the pinion-wheel system is fixedly coupled to the main shaft 7 that engages with a pinion 5 mounted on a shaft of the electric motor 3.

The electric motor 3 is controlled by means of an electronic board 13 situated in the housing 2.

In order to cause the actuator 1 to operate, detection means configured to detect the axial position of the thrust member 18 are provided, these means comprising a permanently-mounted Hall-effect sensor 14 connected to the electronic board 13, and a permanent magnet 17. This magnet 17 is mounted on a support 16 which is coupled to the main shaft 7 by means of a rotary-linear mechanism 15 so that the magnet support can move translationally with respect to the main shaft 7 when the main shaft 7 is rotating. The rotary-linear mechanism 15 is a screw-nut system.

As far as the magnet support 16 more particularly is concerned, this comprises a plastic body provided with an upper region that accepts the magnet 17 and a lower region in the form of a threaded nut configured to engage with a threaded section of the second end 7b of the main shaft 7. The magnet support 16 is preferably clip-fastened onto the threaded nut.

The travels of the two rotary-linear mechanisms 9, 15 are different. In particular, the travel of the first rotary-linear mechanism 15, namely the one associated with the detection system comprising the sensor 14 and the magnet 17 is shorter than the travel of the second rotary-linear mechanism 9 for the thrust member 18. For example, the travel of the first rotary-linear mechanism 15 is 14 mm, and the travel of the second rotary-linear mechanism 9 is 22 mm. In this way, a ratio between the travel of the first rotary-linear mechanism and the travel of the second rotary-linear mechanism is comprised between 0.5 and 0.8. The ratio is preferably 0.7.

Thus, on the basis of the magnetic field generated by the permanent magnet 17 and detected by the sensor 14, the system will know the exact position of the thrust member 18.

The main shaft 7 is supported and guided in rotation by a double-row ball bearing 11. The inner ring of the rolling bearing 11 is in contact with the main shaft 7, and the outer ring of the rolling bearing 11 is in contact with the housing 2 and a flange 10 attached and fixed to the housing 2. The flange 10 also serves to guide the second rotary-linear mechanism 9. A lip seal 12 is housed in the flange 10 and positioned axially between the rolling bearing 11 and the thrust member 18 so as to prevent external contaminants from entering the actuator 1.

FIG. 2 provides a better visual appreciation of the magnet support 16, notably the upper region that accepts the magnet 17 and the lower region in the form of a threaded nut configured to engage with a threaded section of the second end 7b of the main shaft 7. The magnet support 16 is substantially T-shaped, and the two arms of the T of the magnet support 16 are in contact with two planar surfaces 8 of the housing 2 in order to perform an anti-rotation function. The contact is linear with a protuberance 81. The housing 2 thus comprises two planar surfaces 8 along which the two arms of the magnet support 16 slide. The magnet 17 is positioned on one of the two arms of the support 16.

Unlike the first embodiment, the second embodiment illustrated in FIG. 3 does not incorporate a second rotary-linear mechanism. In other words, the first end 7a of the main shaft 7 does not incorporate a screw thread but simply has a surface able to come into contact with an external mechanism. Since the other elements referenced in FIG. 3 are similar to those of FIG. 1 and FIG. 2, they will not be described here.

A third embodiment is illustrated in FIG. 4. Unlike the first and second embodiments, the third embodiment converts a linear movement into rotation. In other words, in the first and second embodiments, the magnet 17 experiences a translational movement, and in the third embodiment, the magnet 17 experiences a rotational movement. In order to achieve this, the first rotary-linear mechanism 15 and, more specifically, its threaded-nut part that engages with the threaded section of the second end 7b of the main shaft 7 comprises a roller cam 151 that engages in a slot 162 of the magnet support 161. A cam-slot system is thus formed between the first rotary-linear mechanism 15 and the magnet support 161. The dynamics involved in the transmission of torque between the electric motor 3 and the main shaft 7 are similar to those in the first and second embodiments.

FIG. 5 provides a better visual appreciation of the cam-slot system between the first rotary-linear mechanism 15 and the magnet support 161. It may be seen that the magnet support 161 is partially housed in a recess in the housing 2 so as to block the translational movement of the magnet support 161 and thus force it to pivot about the axis Z. The slot 162 of the magnet support 161 is oblong in shape. The roller cam 151 is formed as one with the threaded-nut part of the first rotary-linear mechanism 15. In operation, when the threaded-nut part of the first rotary-linear mechanism 15 effects a translational movement, the magnet support 161 pivots about the axis Z. It is therefore possible to acquire the position of the thrust member by detecting the rotation of the magnet 17 associated with a sensor 14 that has not been depicted in this figure.

Although the invention has been described in connection with two particular embodiments, it is quite clear that it is by no means limited thereto and that it includes all the technical equivalents of the means described.

In the claims, the reference symbols between parentheses should not be interpreted as limiting the claim.

1. An electromechanical actuator comprising an electric motor housed in a housing, the electric motor acting on a torque output element able to be coupled to an element of a transmission gearbox of a motor vehicle, the torque output element being connected to the electric motor by drive means, the torque output element being a main shaft configured to rotate about its axis of rotation with a first end and a second end, the actuator further comprising an electronic board situated inside the housing, the electronic board comprising a sensor that faces a magnet mounted on a support coupled to the second end of the main shaft by means of a first rotary-linear mechanism.

2. The electromechanical actuator as claimed in claim 1, wherein the main shaft is connected to the electric motor by means of a pinion-wheel system so as to rotate the main shaft.

3. The electromechanical actuator as claimed in claim 1, wherein the first rotary-linear mechanism is coupled to a surface of the housing in order to perform an anti-rotation function.

4. The electromechanical actuator as claimed in claim 1, wherein the first rotary-linear mechanism is associated with the magnet support by a cam-slot system.

5. The electromechanical actuator as claimed in claim 1, wherein a second rotary-linear mechanism is coupled to the first end of the main shaft.

6. The electromechanical actuator as claimed in claim 5, wherein the travel of the first rotary-linear mechanism is different than the travel of the second rotary-linear mechanism.

7. The electromechanical actuator as claimed in claim 5, wherein the travel of the first rotary-linear mechanism is shorter than the travel of the second rotary-linear mechanism, or the travel of the first rotary-linear mechanism is longer than the travel of the second rotary-linear mechanism.

8. The electromechanical actuator as claimed in claim 1, wherein the main shaft is guided in rotation by a rolling bearing, the inner ring of the rolling bearing being in contact with the main shaft and the outer ring of the rolling bearing being in contact with the housing and a flange fixed to the housing.

9. The electromechanical actuator as claimed in claim 8, wherein the rolling bearing is a double-row ball bearing.

10. The electromechanical actuator as claimed in claim 1, wherein the electric motor comprises a front face facing toward the drive means and a rear face, the housing comprising a removable blanking plug at the rear face of the electric motor.

11. The electromechanical actuator as claimed in claim 2, wherein the first rotary-linear mechanism is coupled to a surface of the housing in order to perform an anti-rotation function.

12. The electromechanical actuator as claimed in claim 2, wherein the first rotary-linear mechanism is associated with the magnet support by a cam-slot system.

13. The electromechanical actuator as claimed in claim 2, wherein a second rotary-linear mechanism is coupled to the first end of the main shaft.

14. The electromechanical actuator as claimed in claim 6, wherein the travel of the first rotary-linear mechanism is shorter than the travel of the second rotary-linear mechanism, or the travel of the first rotary-linear mechanism is longer than the travel of the second rotary-linear mechanism.

15. The electromechanical actuator as claimed in claim 2, wherein the main shaft is guided in rotation by a rolling bearing, the inner ring of the rolling bearing being in contact with the main shaft and the outer ring of the rolling bearing being in contact with the housing and a flange fixed to the housing.

16. The electromechanical actuator as claimed in claim 2, wherein the electric motor comprises a front face facing toward the drive means and a rear face, the housing comprising a removable blanking plug at the rear face of the electric motor.

17. The electromechanical actuator as claimed in claim 3, wherein the first rotary-linear mechanism is associated with the magnet support by a cam-slot system.

18. The electromechanical actuator as claimed in claim 3, wherein a second rotary-linear mechanism is coupled to the first end of the main shaft.

19. The electromechanical actuator as claimed in claim 3, wherein the main shaft is guided in rotation by a rolling bearing, the inner ring of the rolling bearing being in contact with the main shaft and the outer ring of the rolling bearing being in contact with the housing and a flange fixed to the housing.

20. The electromechanical actuator as claimed in claim 3, wherein the electric motor comprises a front face facing toward the drive means and a rear face, the housing comprising a removable blanking plug at the rear face of the electric motor.
